(19) United States
(12) Patent Application Publication
(10) Pub. No.: US 2002/0049646 A1
(43) Pub. Date: Apr. 25, 2002

(54) Method of and apparatus for acquiring new customers, and computer product

(76) Inventors: Michiaki Yokoyama, Osaka (JP); Motoyasu Osuga, Tokyo (JP)

Correspondence Address: STAAS & HALSEY LLP, 700 11TH STREET, NW, SUITE 500, WASHINGTON, DC, 20001, US

(21) Appl. No.: 09/977,404

(22) Filed: Oct. 16, 2001

(30) Foreign Application Priority Data
Oct. 24, 2000 (JP) 2000-324637

(51) Int. Cl. G06F 17/60

(52) U.S. Cl. 705/26; 705/14

(57) ABSTRACT

The company acquires new customer through a homepage. The company sends a request mail to an existing customer to introduce a new customer. The existing customer sends information, which contains name, email address etc. of his friend or acquaintance to the company. The company sends information about the company and good, and services to this friend of the existing customer. The company accepts orders, if any, from this friend. If an order is received from this friend he is registered as existing customer.

### FIELD OF THE INVENTION

The present invention relates to a technology for easily and continuously carrying out an action for causing an existing customer to introduce acquaintances and family as new customers to a company managing a homepage for an Internet business, thereby increasing the number of new customers to be acquired and a computer readable recording medium recording a new customer acquiring program.

### BACKGROUND OF THE INVENTION

Conventionally, there have been known many practical examples of “B to B” (business relations between companies) and “B to C” (business relations between a company and a consumer) for a business system practically using the Internet. In the marketing field, moreover, there have been many practical examples of “B to C” from a company to a consumer and “C to B” for a response thereof which practically use reaction functions such as a web to function, an e-mail to function and the like.

If a sales system practically using the Internet is assumed, only return information between known and concerned people are exchanged between the company and the consumer for relations of the “B to C” to be an outbound from the company and the “C to B” to be a response in the opposite direction thereof. With such relations, accordingly, there has been a problem in that the company maintains “existing customers” but cannot increase the number of new customers to be acquired. Therefore, means and method for effectively eliminating such drawbacks have conventionally been demanded eagerly.

Conventionally, examples of a marketing technique for acquiring new customers on the Internet include a PULL method for giving an advertisement and registering a retrieval engine, increasing the publicity of a company and a homepage managed by the company, causing a customer to designate and buy goods of the company and increasing the number of new customers.

Moreover, there is a PUSH method in addition to the marketing technique using the PULL method. In the PUSH method, a direct mail or the like is directly sent from a company to an expected customer so that a new customer can be acquired to promote the sales.

As described above, conventionally, a new customer has been acquired by using the marketing techniques utilizing the PULL method and the PUSH method. In the PULL method, however, there has been a problem in that a great deal of cost of advertisements is required and it takes a long time to register a well-known retrieval engine. In the PULL method, moreover, even if a customer makes a response (for example, an order) for the “B to C”, the business is only completed and a new customer cannot be acquired.

On the other hand, in the PUSH method, it is premised that a company should grasp attribute information for specifying a customer such as a postal address, a name and an e-mail address of an expected customer and the like. It is necessary to get a customer list to be the attribute information from the inside or the outside. Consequently, there has been a problem in that the cost and time are taken. Moreover, the PUSH method is none other than mass marketing using a kind of the PULL method.

Thus, although the conventional marketing technique using the PULL method and the PUSH method takes a great deal of cost/time for acquiring a new customer, the acquisition of the new customer (the sale) cannot be obtained rapidly.

### SUMMARY OF THE INVENTION

It is an object of the present invention to provide a new customer acquiring method capable of rapidly increasing a new customer (sales) and a computer readable recording medium recording a new customer acquiring program.

According to the present invention, an introduction request mail related to a new customer introduction is transmitted to a terminal of an existing customer of a company to acquire a customer through a Web site; an introduction source entry is accepted from the existing customer; an introduction mail which includes a message for introduction goods and a service of the company is transmitted from the terminal of the existing customer to a terminal of an introduced person; an order and purchase of the goods and the service is accepted from the introduced person induced to the Web site through the introduction mail; and the introduction request mail is transmitted to the terminal of the introduced person by setting the introduced person to be an existing customer only when carrying out the order and purchase.

The computer readable recording medium according to another aspect of the present invention stores a computer program which when executed realizes the method according to the present invention.

According to the present invention, it is possible to rapidly increase the number of new customers (sales) at a lower cost than that in the conventional art through a very simple operation in which the introduction request mail is transmitted to the terminal of the existing customer and the introduction source entry is accepted, and the existing customer then transfers the introduction mail transmitted to the terminal of the existing customer to the terminal of the introduced person. In particular, the existing customer transfers the introduction mail to a plurality of introduced people so that an introduction network and a selling network can be enlarged self-multiplicatively.

Other objects and features of this invention will become apparent from the following description with reference to the accompanying drawings.

### BRIEF DESCRIPTION OF THE DRAWINGS

FIG. 1 is a diagram illustrating the principle of an operation according to an embodiment of the present invention;

FIG. 2 is a block diagram showing a structure according to the embodiment;

FIG. 3 is a diagram showing each file and a message example sentence in a server 100 illustrated in FIG. 2;

FIG. 4 is a flow chart for explaining the operation according to the embodiment;

FIG. 5 is a diagram showing the screen transition of an introduction source terminal 300 illustrated in FIG. 2;

FIG. 6 is a diagram showing the screen transition of an introduction reception terminal 300-1′ illustrated in FIG. 2;

FIG. 7 is a diagram showing an application example of the embodiment; and

FIG. 8 is a block diagram showing a variant of the embodiment.

### DESCRIPTION OF THE PREFERRED EMBODIMENTS

Preferred embodiments of the present invention will be described below in detail with reference to the accompanying drawings.

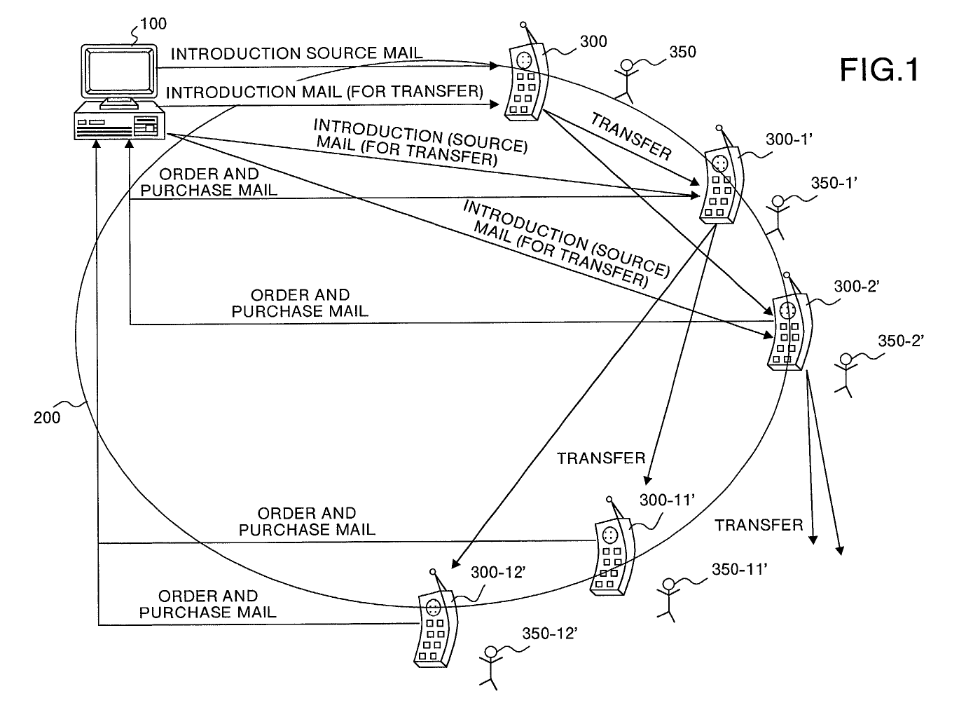

FIG. 1 is a diagram illustrating the principle of an operation according to an embodiment of the present invention. In FIG. 1, a server 100 has a basic function for opening a homepage (EC site) of a company (for example, a distributor or a service industry) to the public and a new customer acquiring function for acquiring a new customer which will be described below. The server 100 is accessed through the Internet 200 to an introduction source terminal 300, an introduction reception terminal 300-1′, an introduction source terminal 300-2′, an introduction reception terminal 300-11′ and an introduction reception terminal 300-12′ which are Internet terminals, and other terminals which are not shown.

The introduction source terminal 300 acts as a mobile telephone terminal owned by an existing customer 350 of a company which is connected to the server 100, a PHS (personal handy phone system) terminal and all kinds of terminals (including ordinary telephone sets) having a transmitting and receiving function for an e-mail of a personal computer or the like, and has a browser function for reading a homepage and an e-mail function for transmitting and receiving an e-mail through the Internet 200. The introduction source terminal 300-1′ and the introduction reception terminal 300-2′ are owned by an introduced person (i.e. a person who is to be introduced) 350-1′ and an introduced person 350-2′ who may be acquaintances or family of the existing customer 350. The introduced person 350-1′ and the introduced person 350-2′ receive the introduction of the company from the existing customer 350 through an e-mail.

The introduction reception terminal 300-11′ and the introduction reception terminal 300-12′ are owned by an introduced person 350-11′ and an introduced person 350-12′ who may be acquaintances or family of the introduced person 350-1′. The introduced person 350-11′ and the introduced person 350-12′ receive, through e-mail, the introduction of the company from the existing customer 350-1′ which has been the customer of the company.

With the above-mentioned structure, the server 100 transmits an introduction request mail and an introduction mail (for transfer) to the introduction source terminal 300 (existing customer 350) through the Internet 200. The introduction request mail makes a request for causing the existing customer 350 to introduce acquaintances and family as new customers to the company. Moreover, the introduction mail (for transfer) serves to introduce the company to the acquaintances and family of the existing customer 350.

When the introduction request mail and the introduction mail (for transfer) are received by the introduction source terminal 300, the existing customer 350 uses the e-mail transfer function of the existing customer 350 to transfer the introduction mail to the introduction reception terminal 300-1′ (or the introduced person 350-1′) and the introduction destination terminal 300-2′ (or the introduced person 350-2′) in order to introduce the company.

When the introduction mail (for transfer) is received by the introduction destination terminal 300-1′, the introduced person 350-1′ reads the homepage of the server 100, and inputs his (her) own personal information (name, postal address and e-mail address) and information about goods and gives an order for the goods. Consequently, the introduced person 350-1′ becomes the new customer (existing customer) of the company. Accordingly, the right to introduce a new customer to the company is given to the introduced person 350-1′.

The introduced person 350-1′ transmits, as the existing customer, the introduction mail (for transfer) to the introduction destination terminal 300-11′ (or the introduced person 350-11′) and the introduction destination terminal 300-12′ (or the introduced person 350-12′) by using the introduction source terminal 300-1′ based on the introduction request mail in the same manner as the existing customer 350.

Similarly, when the introduction mail (for transfer) is received by the introduction destination terminal 300-2′, the introduced person 350-2′ reads the homepage of the server 100, and inputs his (her) own personal information (name, postal address and e-mail address) and information about goods and gives an order for the goods. Consequently, the introduced person 350-2′ becomes the new customer of the company. Accordingly, the right to introduce a new customer to the company is given to the introduced person 350-2′.

Then, the introduced person 350-2′ transmits, as the existing customer, the introduction mail (for transfer) to an introduction destination terminal (not shown) owned by the acquaintances and family based on an introduction request mail in the same manner as the existing customer 350.

It is to be noted that a person receiving the introduction of the company can act as an existing customer to introduce the company to a third party only if the introduced person actually purchases goods or the like and becomes the existing customer in the embodiment. To the contrary, in the embodiment, in the case in which the person receiving the introduction of the company does not actually purchase goods or the like, the same introduced person cannot further introduce the company to a third party. Therefore, this method is entirely different from a pyramid selling method referred to as a pyramid investment scheme on a thought and structure basis.

In the so-called pyramid selling method, it is premised that a continuous introduction generation of a parent, a child, a grandchild, a great-grandchild has an infinite chain. In respect of the fact that a participant himself (herself) of the pyramid selling method expects an income from expansion to two more generations which are not known, accordingly, it is apparent that the motive of an introduction in the pyramid selling method does not reside in the convenience of the distribution of goods or a service but the expectation of profits generated from the introduction chain itself. In the pyramid selling method, therefore, any goods can be sold and are quite different from the normal marketing value in many cases, and furthermore, many goods have no substance as goods, a service or the like.

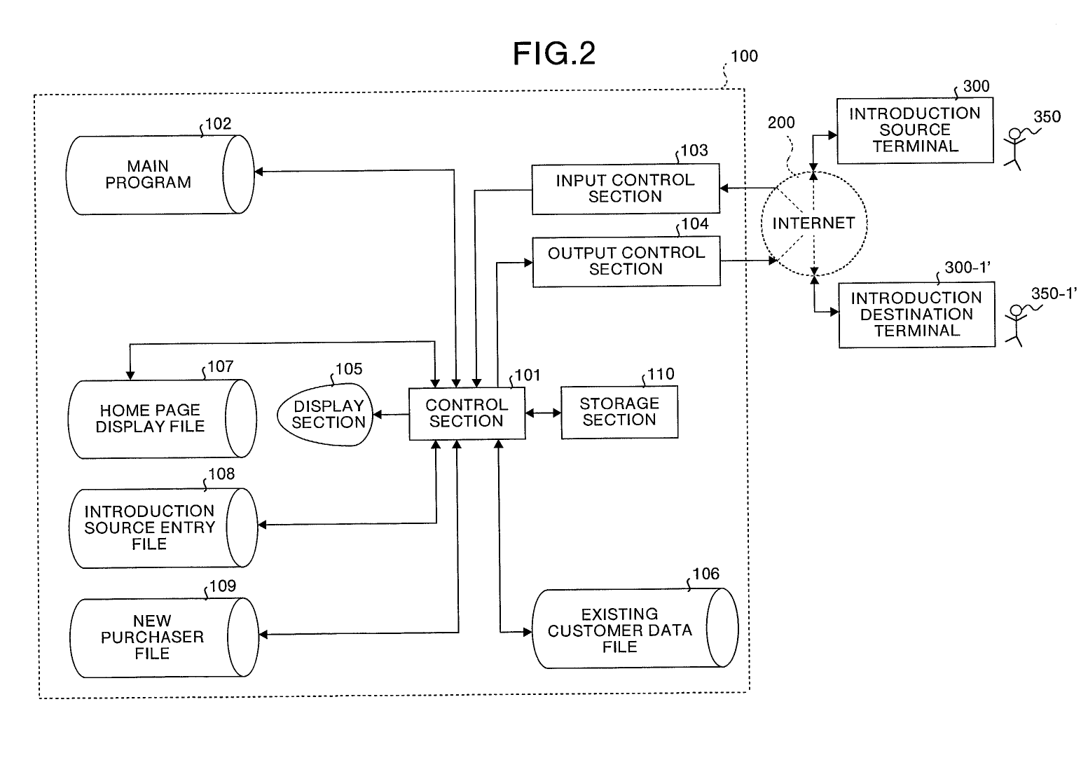

Next, the specific structure according to the embodiment will be described in detail with reference to FIG. 2. FIG. 2 is a block diagram showing a structure according to the embodiment. In FIG. 2, portions corresponding to the portions in FIG. 1 have the same reference numerals. In a server 100, a control section 101 serves to control each portion, and has the function of opening a homepage to the public, an e-mail transmitting and receiving function, a new customer introduction function and the like. The operation of the control section 101 will be described below in detail.

A main program 102 is a computer program to be executed by the control section 101 and serving to implement each function of the server 100. An input control section 103 takes an input interface from the Internet 200 to the control section 101. An output control section 104 takes an output interface from the control section 101 to the Internet 200.

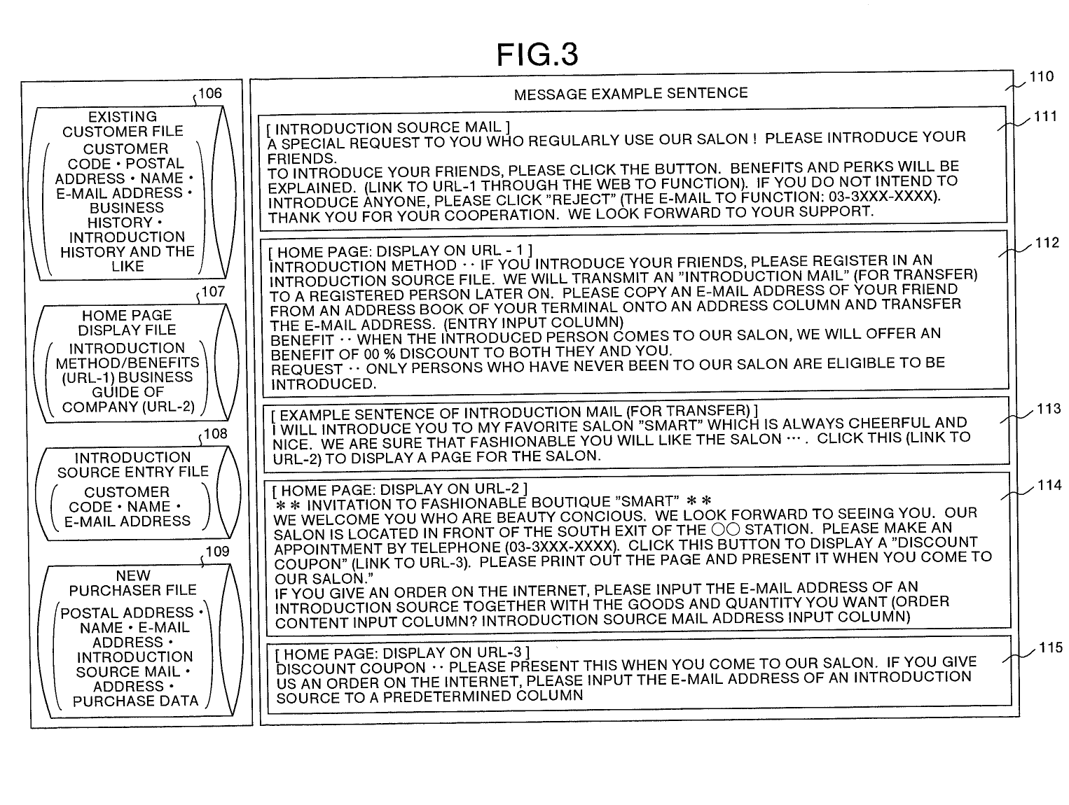

A display section 105 displays various information under control of the control section 101. In the server 100, an existing customer data file 106, a homepage display file 107, an introduction source entry file 108 and a new purchaser file 109 are used. As shown in FIG. 3, the existing customer data file 106 serves to store the existing customer data of the company. The existing customer data include a customer code, a postal address, a name, an e-mail address, a business history, an introduction history and the like.

The homepage display file 107 serves to display the homepage of the company and includes information about a method of introducing a new customer/benefits (URL-1), the business guide (URL-2) of the company and the like. The introduction source entry file 108 is information about an introduction source (existing customer) and includes a customer code, a name, an e-mail address and the like. The new purchaser file 109 is information about a customer newly purchasing goods and a service through a homepage by the introduction of the introduction source (existing customer), and includes a postal address, a name, an e-mail address, an introduction source mail address, purchase data and the like.

A storage section 110 (see FIG. 2) stores a message example sentence 110 to be used in the embodiment. The message example sentence 110 is constituted by messages 111 to 115.

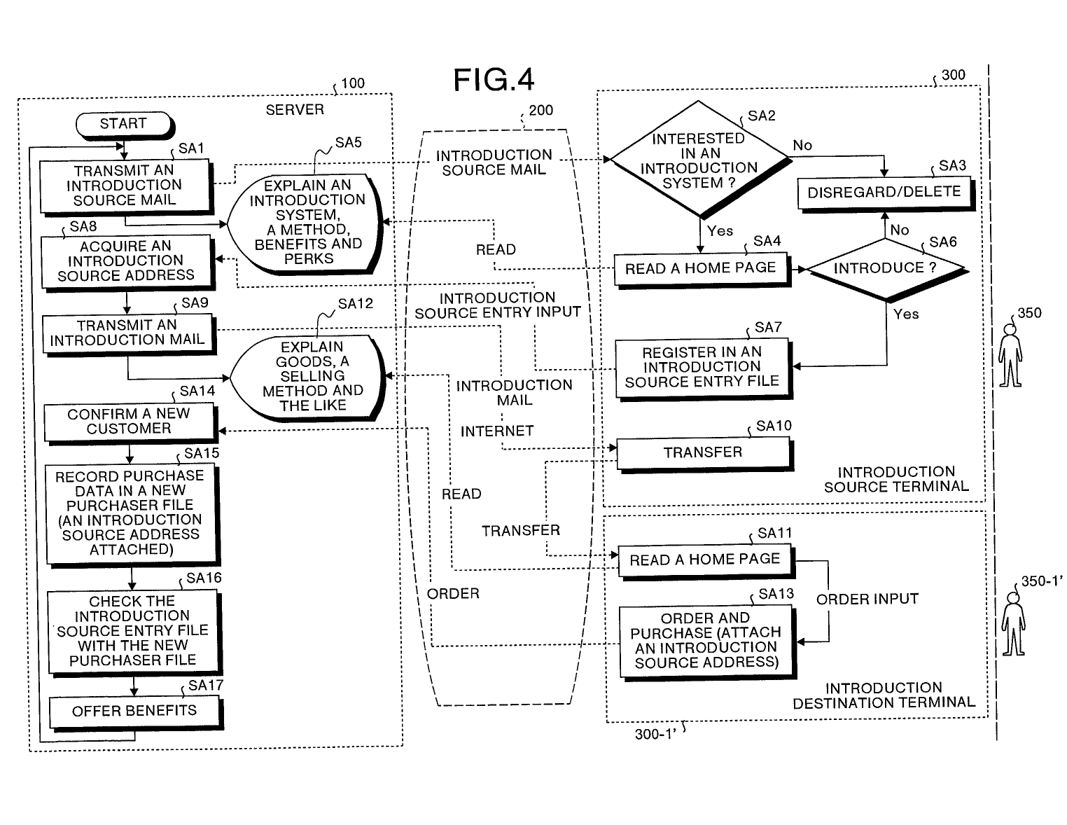

Next, the operation according to the embodiment will be described with reference to FIG. 4 to FIG. 6. The operation of the server 100 which will be described below is actually carried out under control of the control section 101 (see FIG. 2).

At step SA1 shown in FIG. 4, the server 100 transmits an introduction request mail including the message 111 shown in FIG. 3 to an introduction source terminal 300 (existing customer 350) through the Internet 200. When the introduction request mail is received by the introduction source terminal 300, the introduction source terminal 300 makes a sound or an oscillation which represents e-mail receipt.

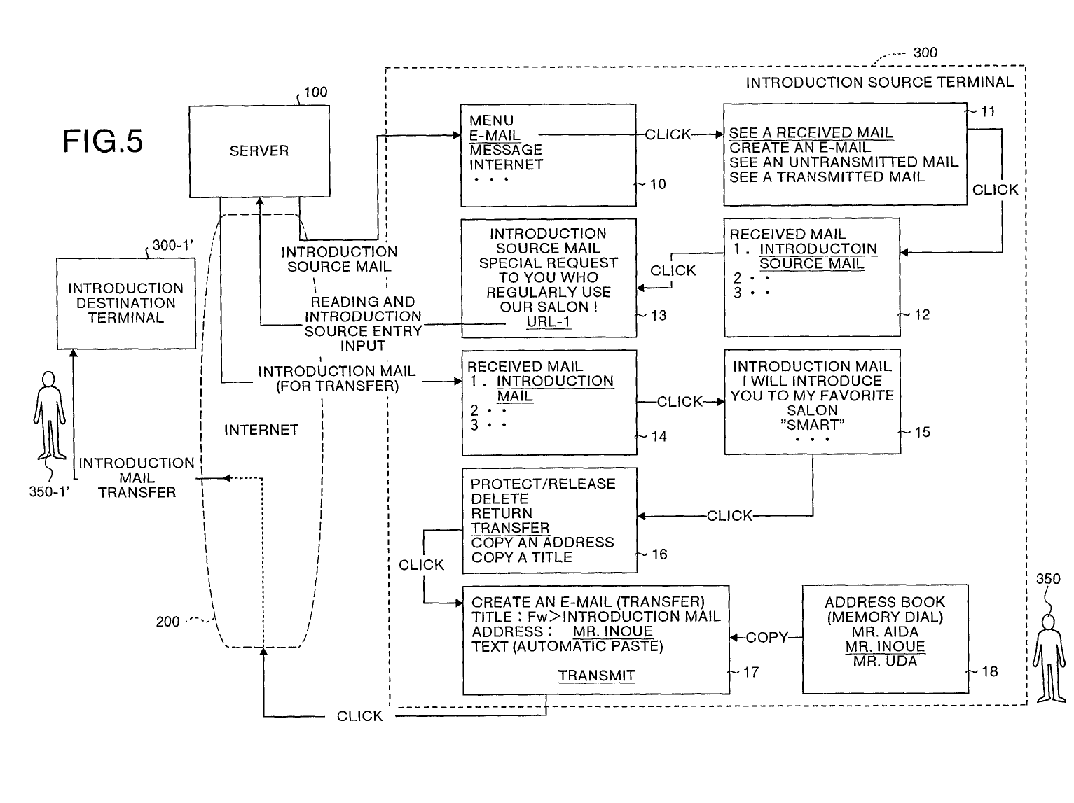

Consequently, the existing customer 350 clicks “e-mail” of a menu screen 10 shown in FIG. 5 and then clicks “see a received mail” of an e-mail operation screen 11. When the existing customer 350 clicks “introduction request mail” of a received mail list 12, the contents (a text and URL-1) of the introduction request mail are displayed on a screen 13. The introduction request mail serves to make a request for the existing customer 350 to introduce a new customer from a company managing a homepage on the server 100.

At step SA2, it is decided whether the existing customer 350 is interested in an introduction system. If the result of the decision is “No”, an introduction request mail is disregarded or deleted at step SA3. On the other hand, if the existing customer 350 is interested in the introduction system, he (she) clicks the “URL-1” on the screen 13 shown in FIG. 5 at step SA4 to indicate the result of the decision in the step SA2 as “Yes”, and reads the homepage of the company.

At step SA5, the server 100 displays a homepage for explaining an introduction system, a method, benefits and perks (see the message 112 in FIG. 3) based on the homepage display file 107 (see FIG. 3). The homepage is linked to the URL-1. At step SA6, the existing customer 350 understands the introduction system, the method, the benefits and perks from the homepage and decides whether acquaintances and family are to be introduced as new customers. If the result of the decision is “No”, the existing customer 350 disregards or deletes the homepage at the step SA3.

On the other hand, if the result of the decision in the step SA6 is “Yes”, the existing customer 350 inputs, to the homepage, the fact that an introduction source entry will be given, thereby carrying out an operation for registering information about the introduction source entry on the introduction source entry file 108. At step SA8, consequently, the server 100 acquires an introduction source address, that is, an e-mail address of the introduction source terminal 300 (existing customer 350) and registers information about the introduction source entry (a customer code, a name, an e-mail address and the like) to the introduction source entry file 108 (see FIG. 3).

At step SA9, the server 100 transmits an introduction mail (for transfer) to the introduction source terminal 300 through the Internet 200. The introduction mail includes the message 113 shown in FIG. 3 and is to be transferred to cause the existing customer 350 himself (herself) to introduce the company to the acquaintances and family.

When the introduction mail (for transfer) is received by the introduction source terminal 300, the existing customer 350 clicks “introduction mail” of a received mail list 14 shown in FIG. 5. Consequently, the contents of the introduction mail are displayed on a screen 15. At step SA10 shown in FIG. 4, the existing customer 350 executes a processing of transferring the introduction mail to the introduced person 350-1′.

More specifically, when an e-mail menu (not shown) is clicked by the existing customer 350, an e-mail menu screen 16 shown in FIG. 5 is displayed. When “transfer” is clicked, a transfer mail creation screen 17 is displayed. Moreover, the existing customer 350 selects “MR. INOUE” (the introduced person 350-1′) to be an e-mail address from an address book screen 18.

Consequently, the “MR. INOUE” (precisely, e-mail address of Mr. INOUE) is set to be a destination for a transfer mail. Next, when “transmit” of the transfer mail creation screen 17 is clicked, the introduction mail (transfer mail) is transferred from the introduction source terminal 300 to the introduction source terminal 300-1′ through the Internet 200. In the case in which the introduction mail is to be transferred to an introduced person other than the introduced person 350-1′, the existing customer 350 repetitively executes the transfer processing.

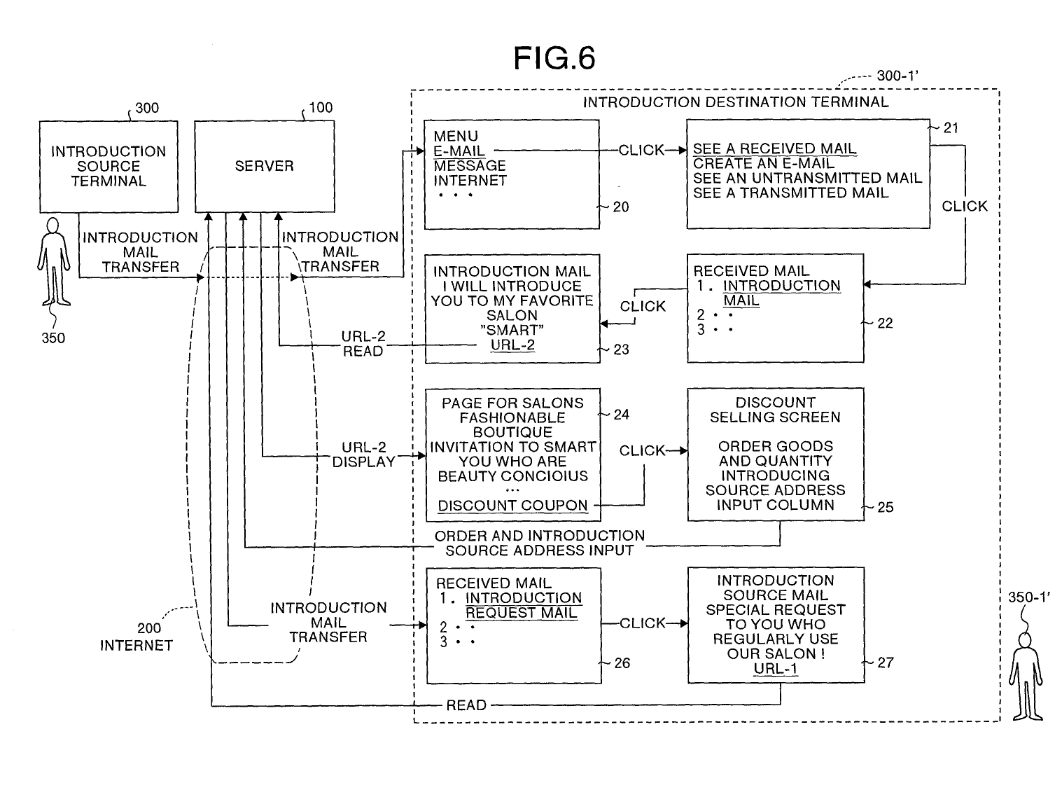

When the introduction mail is received by the introduction destination terminal 300-1′ shown in FIG. 6, the introduction destination terminal 300-1′ makes a sound or an oscillation which represents mail receipt. Consequently, the introduced person 350-1′ clicks “e-mail” of a menu screen 20 and clicks “see a received mail” of an e-mail operation screen 21.

When the introduced person 350-1′ clicks “introduction mail” of a received mail list 22, the contents (a text and URL-2) of the introduction mail are displayed on a screen 23. The introduction mail includes the message 113 shown in FIG. 3 and serves to introduce the company to the introduced person 350-1′.

Next, it is decided whether the introduced person 350-1′ is interested in the company (a homepage, goods and a service). If the result of the decision is “No”, the introduction mail is disregarded or deleted. On the other hand, if the introduced person 350-1′ is interested in the company, he (she) clicks “URL-2” on the screen 23 shown in FIG. 6 and reads the homepage (screen 24) of the company at step SA11.

At step SA12, the server 100 displays, as the screen 24, a homepage for explaining goods, a selling method and the like (see the message 114 in FIG. 3) based on the homepage display file 107 (see FIG. 3). The homepage is linked to the URL-2.

At step SA13, the introduced person 350-1′ carries out an operation for order and purchase when he (she) wants to purchase goods and a service. More specifically, the introduced person 350-1′ clicks “discount coupon” of the screen 24 shown in FIG. 6. The “discount coupon” represents URL-3 (see the message 115 in FIG. 3). Consequently, a discount selling screen 25 is displayed on the introduction destination terminal 300-1′.

The discount selling screen 25 can receive a service such as a discount in an actual store managed by the company. The introduced person 350-1′ inputs, to a predetermined input column, his (her) name, postal address, purchase data, introduction source address (in this case, the e-mail address of the existing customer 350) and the like, and then clicks “order and purchase” (not shown).

At step SA14 shown in FIG. 4, the server 100 refers to the existing customer data file 106 (see FIG. 3) by using the e-mail address of the introduced person 350-1′ as a key, confirms that the introduced person 350-1′ is a new customer and accepts an order. At step SA15, the server 100 records purchase data together with the introduction source address in the novel purchaser file 109 (see FIG. 3).

At step SA16, the server 100 checks the introduction source entry file 108 with the new purchaser file 109 (see FIG. 3) and decides whether the introduction source address related to the introduced person 350-1′ is coincident. If the introduction source address is coincident, the introduction of the introduced person 350-1′ is decided to be the introduction achievement of the existing customer 350. At step SA17, the server 100 offers benefits (incentives) corresponding to the introduction achievement to the existing customer 350.

Subsequently, the introduced person 350-1′ becomes the existing customer. In the same manner as the case of the existing customer 350, therefore, the server 100 transmits the introduction request mail shown in FIG. 6 to the introduction destination terminal 300-1′ based on the address of the new purchaser file 109. When the introduction request mail is received by the introduction destination terminal 300-1′, the introduction destination terminal 300-1′ makes a sound or an oscillation which represents e-mail receipt.

When “introduction request mail” of a received mail list 26 is clicked by the introduced person 350-1′ (existing customer), the contents (a text and URL-1) of the introduction request mail are displayed on a screen 27. The introduction request mail serves to make a request for the introduced person 350-1′ (existing customer) to introduce a new customer from the company managing the homepage on the server 100.

In the same manner as the case of the existing customer 350, subsequently, the introduced person 350-1′ (existing customer) transfers the introduction mail to the introduced person 350-11′ and the introduced person 350-12′ shown in FIG. 1, thereby executing an introduction processing related to the same company. In the case in which the introduced person 350-1′ neither orders nor purchases goods and a service at the step SA13 shown in FIG. 4, he (she) is not the existing customer and the introduction request mail is not transmitted from the server 100 to the introduction destination terminal 300-1′. In this case, accordingly, the introduced person 350-1′ cannot introduce new customers (acquaintances and family) to the company by the above-mentioned new customer acquiring function.

Thus, since the embodiment has the following features, a new customer can be acquired by a method which is quite different from the pyramid selling method.

(1) Also when the existing customer is to introduce acquaintances and family (a first generation) or a second generation, the “introduction request mail” is always transmitted from the company (server 100) every time the introduced person carries out the order and purchase.

(2) The will to carry out introduction for each generation is confirmed and the company is introduced to the next generation only if the introducer obtains a consent (which is different from an infinite multistage chain).

(3) Registration in the new purchaser file 109 is not carried out until the introduced person orders and purchases goods and a service, and the introduction request mail is transmitted to an address registered in the new purchaser file 109. Therefore, even if the multistage chain introduction is consequently carried out, it is possible to reliably distribute goods (or provide a service).

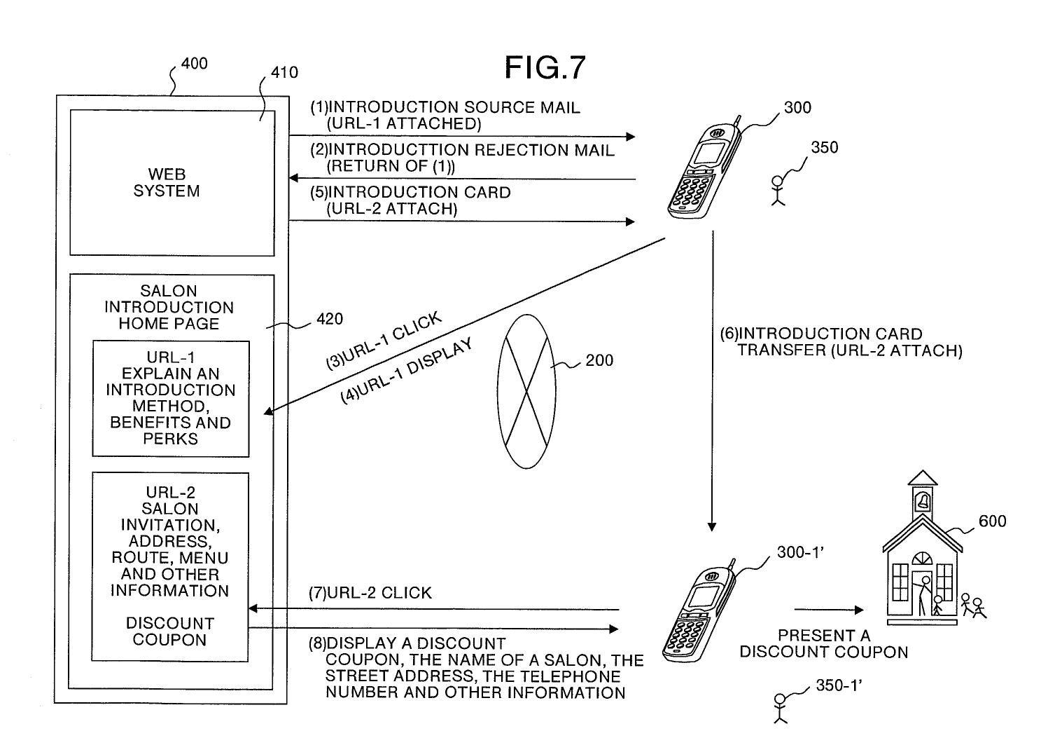

FIG. 7 is a diagram showing an application example of the embodiment described above. In FIG. 7, portions corresponding to the portions of FIG. 2 have the same reference numerals. FIG. 7 shows an example in which the embodiment is applied to beauty salon new customer acquisition. The server 400 has the same function as that of the server 100 shown in FIG. 2. The Web system 410 has the function of opening a homepage to the public and of transmitting and receiving an e-mail. The beauty salon 600 corresponds to a company and opens a solon introduction homepage 420 onto the server 400 in order to acquire a new customer.

With the above-mentioned structure, an introduction request male (URL-1 attached) is transmitted from the server 400 to an introduction source terminal 300 in (1). The following is a sample introduction request mail: “A special request to you who regularly use our salon! Please introduce your friends. To introduce your friends, please click the button. Benefits and perks will be explained. If you do not intend to anyone, please click the “reject” button. Thank you for your cooperation. We look forward to your support.”

If an existing customer 350 rejects the introduction option, an introduction rejection mail is transmitted from the introduction source terminal 300 to the server 400 in (2). Moreover, if the existing customer 350 accepts the introduction, the URL-1 is clicked in (3). In (4), a page for explaining the introduction method corresponding to the URL-1 is displayed on the introduction source terminal 300.

The following is a message sample for this page: “The introduction method . . . we will mail you an introduction card tomorrow. Please correctly transfer the introduction card together with an e-mail address of your friend from an address book of your mobile telephone. Benefit . . . when the introduced person comes to our salon, both they and you will receive a 20% discount. A request . . . Only persons who have never been to our salon are eligible to be introduced. The 20% discount cannot be used in conjunction with any other special offers of our salon”

In (5), an introduction card (URL-2 attached) corresponding to the introduction mail is transmitted from the server 400 to the introduction source terminal 300. In (6), the introduction card (URL-2 attached) is transferred from the introduction source terminal 300 to an introduction reception terminal 300-1′. A sample message for the introduction card: “I will introduce you to my favorite beauty salon “SMART” which is very cheerful and nice. We are sure that fashionable people like you will like the salon . . . Click this link to display a page for the salon.”

In (7), the URL-2 is clicked by the introduced person 350-1′. In (8), the page for the salon invitation, the postal address, a discount coupon or others is displayed on the introduction reception terminal 300-1′. The following is a message sample for this page: “. . . Invitation to the hair salon SMART . . . We welcome you who are beauty conscious. We are expecting you. Our salon is located in front of the south exit of XX station. Please make an appointment by phone. Click this button to display a discount coupon. Please print out the page and present it when you come to our salon.”

Consequently, the introduced person 350-1′ goes to the beauty salon 600 and presents the discount coupon displayed on the introduction destination terminal 300-1′, and can thus receive the new customer discount service.

As described above, according to the embodiment, it is possible to rapidly increase the number of new customers (sales) at a lower cost than that in the conventional art through a very simple operation in which the introduction request mail is transmitted to the introduction source terminal 300 of the existing customer 350 and the introduction source entry is accepted, and the existing customer 350 then transfers the introduction mail transmitted to the introduction source terminal 300 to the introduction destination terminal 300-1′ and an introduction destination terminal 300-2′. In particular, the existing customer transfers the introduction mail to a plurality of introduced people so that an introduction network and a selling network can be enlarged self-multiplicatively.

According to the embodiment, moreover, when the introduced person orders and purchases the goods and the service, the benefits are offered to the existing customer. Therefore, the will of the existing customer to introduce a person can be enhanced. As a result, the number of new customers can further be increased.

According to the embodiment, furthermore, the introduction mail is transferred to the e-mail address (introduction destination terminal) selected from the e-mail address book of the terminal of the existing customer. Therefore, the introduction can readily be carried out through only the simple operation.

According to the embodiment, moreover, the introduced person is caused to input information (the e-mail address or the like) about the existing customer. Therefore, it is possible to clearly couple the introduction source and the introduction destination. Since the introduction source is a purchaser in the former stage for two or more generations. Therefore, the introduction mail can easily be transferred.

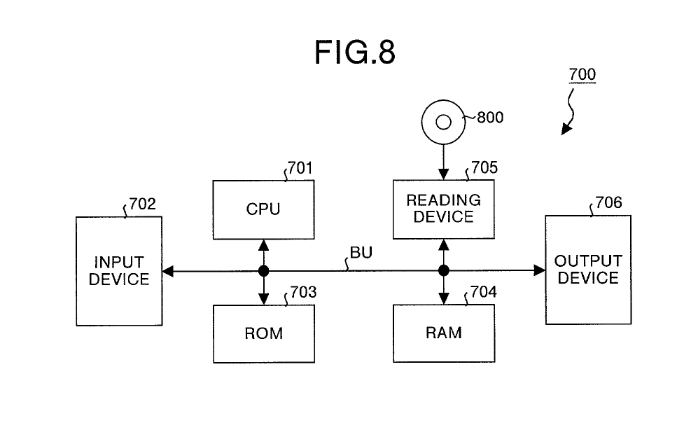

While the embodiment according to the present invention has been described above in detail with reference to the drawings, the specific example of the structure is not restricted to the embodiment but a design can be modified without departing from the scope of the present invention. For example, in the above-mentioned embodiment, the function of acquiring a new customer may be implemented by recording the new customer acquiring program for implementing the new customer acquiring method in a computer readable recording medium 800 shown in FIG. 8 and reading and executing the new customer acquiring program recorded in the recording medium 800 through a computer 700 shown in FIG. 8.

The computer 700 shown in FIG. 8 is constituted by a CPU 701 for executing the new customer acquiring program, an input device 702 such as a keyboard or a mouse, an ROM (Read Only Memory) 703 for storing various data, an RAM (Random Access Memory) 704 for storing an operation parameter or the like, a reading device 705 for reading the new customer acquiring program from the recording medium 800, an output device 706 such as a display or a printer, and a bus BU for connecting each portion of the devices.

The CPU 701 provides the function of acquiring a new customer by reading the new customer acquiring program recorded in the recording medium 800 through the reading device 705 and then executing the new customer acquiring program. The recording medium 800 includes a portable recording medium such as an optical disk, a floppy disk or a hard disk, and furthermore, a transmission medium for temporarily recording and holding data as in a network.

While the example of application to the beauty business has been described in the embodiment, application to all fields can be carried out in order to promote the sales. In the following, examples of the application field will be described.

(a) Field in which diversification and discrimination can be carried out based on the static attribute of a customer

Service business such as barbers, a beauty salon or a private learning school

Sales promotion for each age group

Sales promotion based on a birthday, a constellation or a blood type

Sales promotion based on a family make-up

(b) Field in which diversification and discrimination can be carried out based on the dynamic attribute of a customer

Selling service for selling durable consumer goods such as automobiles or household electrical appliances,

Sales promotion based on purchase at a first time (business continuation period)

Sales promotion based on the number of time of the purchase or the frequency of the purchase

Sales promotion based on a purchase price

Sales promotion based on purchase achievement of related goods (series cosmetics or the like)

Sales promotion for estranged and dormant customers

Sales promotion based on introduction achievement

As described above, according to the present invention, it is possible to rapidly increase the number of new customers (sales) at a lower cost than that in the conventional art through a very simple operation in which the introduction request mail is transmitted to the terminal of the existing customer and the introduction source entry is accepted, and the existing customer then transfers the introduction mail transmitted to the terminal of the existing customer to the terminal of the introduced person. In particular, the existing customer transfers the introduction mail to a plurality of introduced people so that an introduction network and a selling network can be enlarged self-multiplicatively.

According to the present invention, moreover, in the case in which the introduced person orders and purchases the order and service, the incentive is given to the existing customer. Therefore, the will of the existing customer to introduce a person can be enhanced. As a result, the number of new customers can further be increased.

According to the present invention, furthermore, the introduction mail is transferred to the e-mail address selected from the e-mail address book of the terminal of the existing customer. Therefore, the introduction can readily be carried out through only the simple operation.

According to the present invention, moreover, the introduced person is caused to input information about the existing customer. Therefore, it is possible to clearly couple the introduction source and the introduction destination. Since the introduction source is a purchaser in the former stage for two or more generations. Therefore, the introduction mail can easily be transferred.

Although the invention has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth.

What is claimed is:

1. A method of acquiring new customers, the method comprising the steps of:
transmitting an introduction request mail related to a new customer introduction to a terminal of an existing customer of a company to acquire a customer through a Web site;
accepting an introduction source entry from the existing customer;
transmitting, to the terminal of the existing customer, an introduction mail which includes a message for introduction goods and a service of the company from the terminal of the existing customer to a terminal of an introduced person and is to be transferred from the terminal of the existing customer to the terminal of the introduced person;
accepting an order and purchase of the goods and the service from the introduced person induced to the Web site through the introduction mail; and
transmitting the introduction request mail to the terminal of the introduced person by setting the introduced person to be an existing customer only when carrying out the order and purchase.

2. The method according to claim 1, further comprising a step of giving an incentive to the existing customer when the introduced person orders and purchases the order and service.

3. The method according to claim 1, wherein the introduction mail is transferred to an e-mail address selected from an e-mail address book of the terminal of the existing customer.

4. The method according to claim 1, wherein the introduced person is made to input information about the existing customer at the order and purchase accepting step.

5. A computer readable medium for storing instructions, which when executed on a computer, causes the computer to perform the steps of:
transmitting an introduction request mail related to a new customer introduction to a terminal of an existing customer of a company to acquire a customer through a Web site;
accepting an introduction source entry from the existing customer;
transmitting, to the terminal of the existing customer, an introduction mail which includes a message for introduction goods and a service of the company from the terminal of the existing customer to a terminal of an introduced person and is to be transferred from the terminal of the existing customer to the terminal of the introduced person;
accepting an order and purchase of the goods and the service from the introduced person induced to the Web site through the introduction mail; and
transmitting the introduction request mail to the terminal of the introduced person by setting the introduced person to be an existing customer only when carrying out the order and purchase.

6. An apparatus for acquiring new customers, said apparatus comprising:
a first transmitting unit which transmits an introduction request mail related to a new customer introduction to a terminal of an existing customer of a company to acquire a customer through a Web site;
an entry accepting unit which accepts an introduction source entry from the existing customer;
a second transmitting unit which transmits, to the terminal of the existing customer, an introduction mail which includes a message for introducing goods and a service of the company from the terminal of the existing customer to a terminal of an introduced person and is to be transferred from the terminal of the existing customer to the terminal of the introduced person;
an order and purchase accepting unit which accepts an order and purchase of the goods and the service from the introduced person induced to the Web site through the introduction mail; and
a third transmitting unit which transmits the introduction request mail to the terminal of the introduced person by setting the introduced person to be an existing customer only when carrying out the order and purchase.

7. The apparatus according to claim 6, further comprising an incentive giving unit which gives an incentive to the existing customer when the introduced person orders and purchases the order and service.

8. The apparatus according to claim 6, wherein the introduction mail is transferred to an e-mail address selected from an e-mail address book of the terminal of the existing customer.

9. The apparatus according to claim 6, wherein said order and purchase accepting unit makes the introduced person to input information about the existing customer.
